(19) United States
(12) Patent Application Publication
(10) Pub. No.: US 2007/0039153 A1
(43) Pub. Date: Feb. 22, 2007

(54) Method for forming a tool and a tool

(76) Inventor: Mark Manuel, Shelby Township, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/206,502

(22) Filed: Aug. 18, 2005

(51) Int. Cl. B23Q 17/00

(52) U.S. Cl. 29/407.1; 29/428

(57) ABSTRACT

A tool 10 and a methodology for creating the tool 10 in which welded joints are used to secure pairs of adjacent sectional members, such as sectional members 12, 14 in order to cause the created tool 10 to have a desirable physical attributes and a desirable and relatively long operative life.

### FIELD OF THE INVENTION

The present invention generally relates to a method for forming a tool and to a tool and, more particularly, to a laminated tool having superior strength and other highly desirable physical properties due to the use of a new and novel attachment strategy which is employed in the overall tool creation process.

### BACKGROUND OF THE INVENTION

A tool is an entity which is selectively used to create a physical or tangible item, such as a portion of a vehicle. While traditional tools vary in their size and overall geometric configuration, they are typically formed or manufactured from a substantially solid “block” of material. Particularly, the block of material is manually or physically “worked” or machined to form the desired tool by the use of various implements.

While the foregoing traditional approach does produce a tool having a desired size and shape, the process is time-consuming, costly, and prone to error as most of the forming activity is done in a manual fashion.

To overcome some or all of the drawbacks associated with traditional tool forming strategies, a laminated tooling approach is often utilized. Particularly, this approach requires the creation of an intangible or “soft” model of the overall tool (typically formed within software) which is then intangibly sectionalized.

Each of the intangible sectional members are then physically constructed or manifested and sequentially and physically coupled in a manner which allows the coupled sectional members to cooperatively form the desired tool. One approach to realizing this lamination strategy is set forth within U.S. Pat. No. 6,587,742 (“The '742 Patent”) which is assigned to the assignee of this application and which is fully and completely incorporated herein by reference, word for word and paragraph for paragraph. Particularly, each sectional member is constructed and its geometric properties (e.g., its size and shape) depend upon certain measurements which are made of the sectional member to which it is to be attached to and which has been previously and physically constructed.

While these lamination strategies do allow a tool to be cost effectively and accurately created, sometimes the created tools do not have the structural strength or integrity to desirably function over a relatively long period of time and may be prone to damage or failure. These drawbacks are due to the use of the several individual sectional members which are used to create the tool and, more particularly, to the need to couple these members by various connection strategies, which provide varying amounts of structural integrity and strength (e.g., the required coupling may provide a tool having undesirable strength and an undesirable operating life).

There is therefore a need for a new and improved lamination strategy which allows a laminated tool to be selectively created in a manner which allows a laminated tool to be cost effectively created and to have very desirable physical properties which allow the created tool to operatively and desirably function over a relatively long period of time.

### SUMMARY OF THE INVENTION

It is a first non-limiting object of the present invention to provide a laminated tool which overcomes some or all of the drawbacks associated with tools.

It is a second non-limiting object of the present invention to provide a laminated tool which overcomes some or all of the drawbacks associated with tools and which, by way of example and without limitation, includes desirable physical properties which allow the produced tool to operatively function over a relatively long period of time.

It is a third non-limiting object of the present invention to provide a method for producing a laminated tool which overcomes some or all of the drawbacks associated with conventional tooling strategies and methodologies.

It is a fourth non-limiting object of the present invention to provide a method for producing a laminated tool which overcomes some or all of the drawbacks associated with conventional tooling strategies and methodologies and which, by way of example and without limitation, selectively produces a tool having desirable physical properties and which may be operatively utilized for a relatively long period of time.

According to a first non-limiting aspect of the present invention, a tool is provided and includes a first sectional member having a hole; and a second sectional member which is coupled to said first sectional member; and a welded joint which is formed through said hole which is formed within said first sectional member and which attaches said second sectional member to said first sectional member.

According to a second non-limiting aspect of the present invention, a tool is provided and includes a first sectional member having a protuberance; a second sectional member which includes a cavity having an interior portion which receives the protuberance, thereby coupling the first sectional member to the second sectional member; and a welded joint which is formed within the cavity and which couples the protuberance to the interior portion of the cavity.

According to a third non-limiting aspect of the present invention, a method for forming a tool is provided and includes the steps of creating a first sectional member; measuring at least one parameter of the first sectional member; using the at least one parameter to form a second sectional member; forming an opening within the first sectional member; and forming a welded joint within and through the opening; and causing said welded joint to couple the first sectional member to the second sectional member while residing only within the first and second members.

These and other features, aspects, and advantages of the present invention will become apparent from a reading of the following detailed description of the preferred embodiment of the invention, including the subjoined claims, and by reference to the following drawings.

### BRIEF DESCRIPTION OF THE DRAWINGS

FIG. 1 is a perspective view of a portion of a laminated tool being created by the use of a laser welding assembly;

FIG. 2 is a partial side sectional view of two sectional members being joined in accordance with a first non-limiting embodiment of the invention;

FIG. 3 is a partial side sectional view of two sectional members being joined in accordance with the teachings of a second non-limiting embodiment of the invention;

FIG. 4 is a partial side sectional view of two sectional members being joined in accordance with the teachings of a third non-limiting embodiment of the invention;

FIG. 5 is a top view of one of the sectional members which is shown in FIG. 4;

FIG. 6 is a top view of one of the sectional members which is shown in FIG. 4 according to the teachings of another alternate embodiment of the invention; and

FIG. 7 is a top view of one of the sectional members which is shown in FIG. 1 being cleaned according to the teachings of yet another alternate embodiment of the invention.

### DETAILED DESCRIPTION OF THE PREFERRED EMBODIMENT OF THE INVENTION

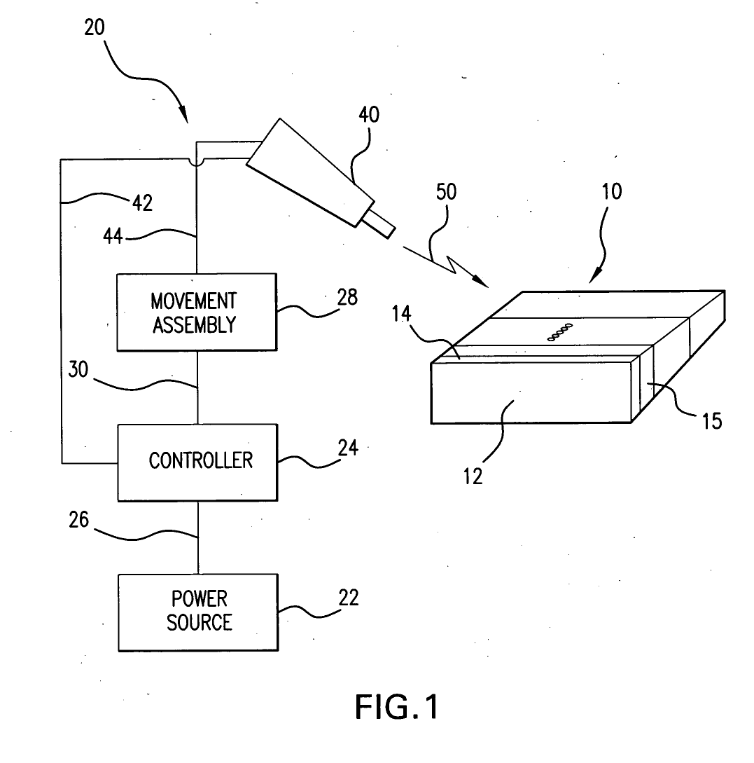

Referring now to FIG. 1, there is shown a portion of a laminated tool 10 which is made in accordance with the tool creation strategy of the preferred embodiment of the current invention.

Particularly, as should be known to those of skill in this art, the tool 10 is created by the use of several sectional members, such as sectional members 12, 14, 15, which are softly or intangibly created, physically manifested, and then joined together to cooperatively form the tool 10. One non-limiting example of such a lamination process is found within The '742 Patent.

According to the teachings of the present invention, a laser welding assembly, such as laser welding assembly 20, is used to effectuate the connection of the various physically manifested sectional members, such as members 12, 14, 15, which form the tool 10. It should be realized, at the outset, that the present invention is not limited to any particular type of tool or to any particular type of laser welding assembly. Rather, the teachings of the present invention are-generally applicable to a wide range of tools and may utilize a wide range of laser welding assemblies, including but not limited to those which are shown in FIG. 1.

The laser welding assembly 20 includes a source of electrical power 22 (which may comprise a power supply portion which is adapted to be selectively coupled to a source of electrical power), and a controller assembly 24 which is operable under stored program control and which is physically and operatively coupled to the power source 22 by the bus 26. The laser welding assembly 20 further includes a movement assembly 28 which is physically and operatively coupled to the controller 24 by the use of bus 30 and which, in one non-limiting embodiment, may comprise one or more “servo-type” motors which cooperatively and selectively provide movement in a plurality of degrees of freedom. The laser welding assembly 20 further includes a laser application head assembly 40 which is physically and controllably coupled to the controller 24 by the bus 42 and to the movement assembly 28 by the member 44. The laser application head 40 comprises, at least in part, a laser energy generation assembly which is adapted to selectively emit laser energy 50.

In operation, the controller 24 is made to selectively receive the required movement patterns to operatively position the assembly 40 in a manner which allows the sectional members, such as sectional members 12, 14, 15 to be desirably coupled and connected by the laser energy 50 which is emitted from the laser head assembly 40. Such movement patterns are typically communicated to the controller assembly 24 by a user of the assembly 20 and subsequently made to storably reside within the controller assembly 24. Further, the received movement patterns include energy generation commands, created by the user, which specify the required energy generation at certain locations of the head assembly 40 within the desired and specified movement patterns.

The controller assembly 24 then moves the assembly 28, by the use of commands which are placed upon the bus 30 and in accordance with the stored movement patterns. The movement assembly 28 then moves, in accordance with the received commands, and such movement is imparted to the head assembly 40 by the use of member 44. Energy 50 is selectively emitted from the head assembly 40 upon receipt of commands which are created by the controller 24 and communicated to the head 40 by the use of bus 42. In this manner, the laser emission head assembly 40 is selectively moved and selectively emits energy 50 in a manner which allows the tool 10 to be created by the use of various sectional members, such as sectional members 12, 14, 15 (e.g., in a manner which allows laser welded joints to be created within the created tool 10).

Particularly, the selectively emitted laser energy 50 is used to create laser weld type joints between two adjacent sectional members, such as sectional members 12, 14, 15. Various types of joints may be created, however, as will be seen below, the efficacy of these different joints dramatically varies. It will be realized that while the following discussion describes the selective creation of laser type welded joints between adjacent sectional members 12, 14, that the discussion is equally applicable to substantially similar joints which may be selectively created between each pair of adjacent type sectional members which are used to cooperatively create the tool 10. Further, it should be realized that these various sectional members which cooperatively form the tool 10 may also be coupled by other additional techniques or strategies (e.g., by use of a bounding material) in addition to the use of laser welded joints. Further, it should be appreciated that the overall number and placement of such joint may vary, as desired, within the created tool.

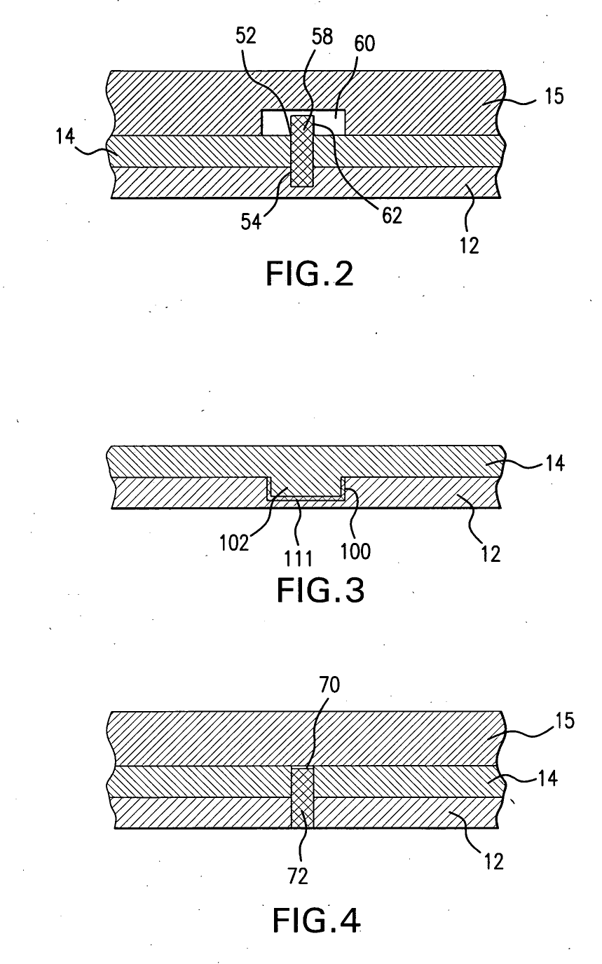

Referring now to FIG. 2, there is shown adjacent sectional members 12, 14, 15. Particularly, as shown, in this first non-limiting embodiment, an opening 52 is created and/or formed within the sectional member 14 and a second opening 54 is created and/or formed within the sectional member 12 and is communicatively registered with the opening 52 when the sectional member 14 is made to be operatively adjacent to the sectional member 12. In one non-limiting embodiment, the opening 52, 54 are substantially similar. The laser assembly 20 is then made to cause energy 50 to form a welded joint 58 through the openings 52, 54 which is effective to join the sectional member 12 to sectional member 14. In this first approach, the welded joint 58 protrudes through the communicatively registered openings 52, 54. It should be appreciated that the welded joint 58 is formed by the melting of the portion of members 12, 14 which respectively reside within and bound the openings 54, 52 and the subsequent cooling of these melted portions when the energy 50 is removed.

Although this first approach does allow the adjacent sectional members 12, 14 to be physically joined by the use of the selectively emitted energy 50, the protrusion of the created welded joint 58, through the openings 52, 54, causes the next adjacent member 15 to be required to have a slot or recess portion 60 which receives the protruding portion 62 of the welded joint 58. Such a recess 60 is, of course, undesirable since it structurally weakens the sectional member 15 and as the number of such protruding welded joints 58 increases within the tool 10, the number of such recesses 60 concomitantly increases and the structural integrity of the tool 10 decreases, thereby making the created tool 10 prone to failure while having a rather limited working life.

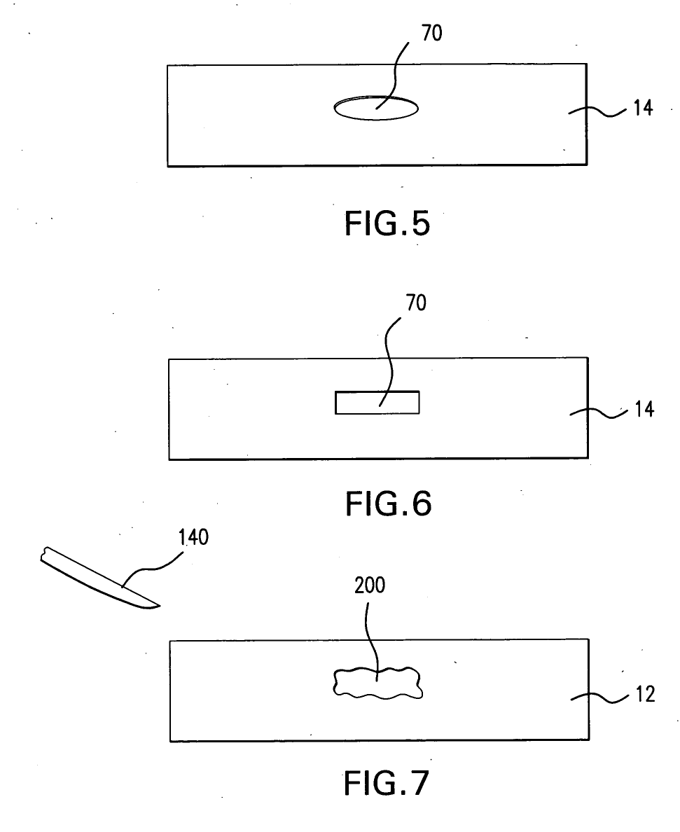

A second approach or strategy, as best shown in FIG. 4, requires the creation of a slot or opening 70 within one of the adjacent sectional members, such as sectional member 14. After the pair of adjacent sectional members are made to be operatively abutted (e.g., sectional members 12, 14) the energy 50 is then directed into the opening 70, thereby forming a welded joint 72 which does not protrude out of the slot or opening 70 and is wholly and completely contained within the slot or opening 70 and within the abutted and adjacent sectional members (e.g., members 12, 14). In this manner, the sectional member 15 lies relatively flat against the sectional member 14, thereby allowing for the creation of a tool 10 having enhanced physical features and attributes. As shown in FIGS. 5 and 6, the opening or slot 70 may have a substantially rectangular or circular shape, or substantially any other desired shape.

A third approach, which is best shown in FIG. 3, requires that a recess 100 be formed within a first of the adjacent pairs of sectional members, such as sectional member 12, and a protruding member, such as protruding member 102, may be formed within a second of the adjacent pair of sectional members, such as sectional member 14. This protruding member 102 is selectively placed within the formed recess 100, which, in most preferred embodiment is slightly larger in diameter than the member 102, thereby connecting the sectional member 12 to sectional member 14. Then, the energy 50 is made to enter the slightly larger recess 100, thereby causing the member 102 to be weldably connected to the interior 110 of the recess 100 by the use of welded joint 111. In this manner, the “press fit” connection comprising the cooperative combination of the member 102 and the recess 100 cooperates with the welded joint 111 to provide a sturdy connection, which sturdily allows the members 12, 14 to be coupled without the use of a recess 60 within the next adjacent sectional member 15. Such a press-fit arrangement is in fully described within pending U.S. patent application Ser. No. 10/794,011, which is fully and completely incorporated herein by referenced and which is owned by the assignee of this application and which was filed on March 5, 2004. In yet another non-limiting embodiment, the laser connections fixture the tool (e.g., hold it in place or. “together”) until it may be brazed.

In yet another non-limiting embodiment of the invention, an air knife 140 is used to prevent weld spatter from attaching to the plate surface by use of a stream fair. Additionally, air knife 140 may be used to trim any and all protruding welded joints which protrude from the surface of a sectional member, such as welded joint 200 from sectional member 12.

It is to be understood that the present invention is not limited to the exact construction or embodiments which are delineated above, but that various modifications may be made without departing from the spirit and the scope of the inventions as are delineated in the following claims. It should be further understood that the energy 50 may comprise non-laser type energy (e.g., ultrasonic type energy). It should be further appreciated that this energy provides for less structural distortion in the assembled tool than previous joining techniques and strategies.

What is claimed is:

1) A tool comprising a first sectional member having a hole; and a second sectional member which is coupled to said first sectional member; and a welded joint which is formed through said hole which is formed within said first sectional member and which attaches said second sectional member to said first sectional member.

2) The tool of claim 1 wherein said hole comprises a slot.

3) The tool of claim 2 wherein said welded joint is wholly and completely resident within said first and second sectional members.

4) The tool of claim 3 wherein said welded joint comprises a laser welded joint.

5) The tool of claim 4 wherein said slot is thin.

7) A tool comprising a first sectional member having a protuberance; a second sectional member which includes a cavity having an interior portion which receives said protuberance, thereby coupling said first sectional member to said second sectional member; and a welded joint which is formed within said cavity and which couples said protuberance to the interior portion of said cavity.

8) The tool of claim 7 wherein said welded joint comprises a laser welded joint.

9) The tool of claim 8 wherein said welded joint is wholly and completely resident within said cavity.

10) A method for forming a tool, said method comprising the steps of creating a first sectional member; measuring at least one parameter of said first sectional member; using said at least one parameter to form a second sectional member; forming an opening within said first sectional member; and forming a welded joint within and through and causing said welded joint to couple said first sectional member to said second sectional member.

11) The method of claim 10 wherein said method further comprises the steps of welded joint comprises a laser welded joint.

12) The method of claim 11 wherein said laser welded joint is wholly and completely resident within the confines of said first and second sectional members.

13) A method for forming a tool, said method comprising the steps of creating a first sectional member having a protuberance; measuring at least one parameter of said first sectional member; forming a second sectional member by use of said at least one parameter, wherein said second sectional member includes a cavity; placing said protuberance within said cavity, thereby attaching said first sectional member to said second sectional member; and forming a welded joint within said cavity.

14) The method of claim 13 wherein said welded joint comprises a laser welded joint.

15) The method of claim 14 wherein said welded joint is wholly and completely resident within said cavity.

16) A method for forming a tool comprising the steps of forming a first sectional member; forming a second sectional member; and forming a laser welded joint which operatively extends within and is wholly and completely disposed within said first and second sectional members, thereby coupling said first sectional member to said second sectional member.

17) The method of claim 16 wherein said method further comprises the steps of taking at least one measurement of said first sectional member; and using said at least one measurement to create said second sectional member.
